(19) United States
(12) Patent Application Publication
(10) Pub. No.: US 2022/0270117 A1
(43) Pub. Date: Aug. 25, 2022

(54) VALUE RETURN INDEX SYSTEM AND METHOD

(71) Applicants: Christopher Copeland, Kirkwood, MO (US); Jesse Wolfersberger, Chesterfield, MO (US)

(72) Inventors: Christopher Copeland, Kirkwood, MO (US); Jesse Wolfersberger, Chesterfield, MO (US)

(21) Appl. No.: 17/676,724

(22) Filed: Feb. 21, 2022

Related U.S. Application Data
(60) Provisional application No. 63/152,671, filed on Feb. 23, 2021.

(51) Int. Cl. G06Q 30/02

(52) U.S. Cl. CPC G06Q 30/0201; G06Q 30/0205; G06Q 30/0282

(57) ABSTRACT

A value return index system is disclosed. The system value return index system comprises a user interface via a user client device on a computer network, the user interface including one or more fields to receive user data selections to display (1) a brand value landscape view wherein a brand value is selected by the user and brand competitors are compared as to brand value awareness and calculated value consideration or a brand landscape view wherein a brand is selected by the user and brand values are compared with respect to value awareness and calculated value considerations. The value return index system incorporates one or more servers on the computer network that are programmed to determine an expected purchase propensity score for users and brands by training a machine learning algorithm using a framework of actual purchase data and the user demographic data, brand data and the social media data relating to the brands to create a model for calculating a prediction value of likelihood of a user to purchase a brand.

### CROSS-REFERENCE TO RELATED APPLICATIONS

This application claims priority to U.S. provisional application No. 63/152,671, filed Feb. 23, 2021, entitled “Data System for Measuring the Purchase Equity Created from Brand Values,” which is incorporated by reference herein

### FIELD OF THE INVENTION

The present invention relates to a value return system and method.

### BACKGROUND OF THE INVENTION

A purchase funnel is a consumer-focused marketing model known to those skilled in the art that illustrates the theoretical customer journey toward the purchase of a good or service. The purchase funnel generally consists of (1) awareness of a brand, (2) opinion of the brand, (3) consideration of the brand, preference of the brand and (4) purchasing the brand. There are tools that exist that measure the ebbs and flows of the upper funnel brand sentiment. BERA, Brandwatch and Bain's Net-promoter-score are examples of such tools. None of these tools however quantify the impact of the brand in terms of revenue. In one example tool, a score (e.g., 85) is generated that predicts a brand's impact on a business. However, this score fails to provide any insight or understanding for the brand in terms of consumer purchasing or financial implications.

### SUMMARY OF THE INVENTION

A value return index system and method are disclosed.

In accordance with an embodiment of the present disclosure, a value return index system is disclosed comprising: (a) a first database for storing tabular data including (1) a plurality of assigned user IDs for a plurality of users, (2) corresponding user demographics data including, age, gender and location for the plurality of users, (3) corresponding user data relating to one or more brands and (4) social media data relating to the one or more brands and (b) one or more servers communicating with the database and programmed to: retrieve the assigned user IDs and the one or more brands from the first database and generate a second database of tabular data including data within a plurality of rows of the assigned user IDs and the one or more brands; merge the user data relating to one or more brands and demographic data into the second database; aggregate the social media data relating to the one or more brands by location and assigned user ID and merge the social media data into the second database; determine expected purchase propensity score for every user of the plurality of users and brand in the second database by training a machine learning algorithm using a framework of (1) actual purchase data and (2) the user demographic data, brand data and the social media data relating to the brands to create a model for calculating a prediction value of likelihood of a user to purchase a brand; and calculate prediction value of likelihood of each user to purchase each brand based on the created model and a residual value representing the accuracy of the calculated prediction value and merge prediction value and residual value in database.

In accordance with an embodiment of the present disclosure, a value return index method is disclosed comprising: receiving over a computer network, at one or more servers, tabular data including (1) a plurality of assigned user IDs for a plurality of users, (2) corresponding user demographics data including, age, gender and location for the plurality of users, (3) corresponding user data relating to one or more brands and (4) social media data relating to the one or more brands; retrieving, by the one or more servers, the assigned user IDs and the one or more brands and generate a database of tabular data including data within a plurality of rows of the assigned user IDs and the one or more brands; merging, by the one or more servers, the user data relating to one or more brands and demographic data into the database; aggregating, by the one or more servers, the social media data relating to the one or more brands by location and assigned user ID and merge the social media data into the database; determining, by the one or more servers, an expected purchase propensity score for every user of the plurality of users and brand in the database by training a machine learning algorithm using a framework of (1) actual purchase data and (2) the user demographic data, brand data and the social media data relating to the brands to create a model for calculating a prediction value of likelihood of a user to purchase a brand; and calculating, by the one or more servers, a prediction value of likelihood of each user to purchase each brand based on the created model and a residual value representing the accuracy of the calculated prediction value and merge prediction value and residual value in database.

In accordance with another embodiment of the disclosure, a value return index system is disclosed comprising: a user interface via a user client device on a user on a computer network, the user interface including one or more fields to receive user data selections to display (1) a brand landscape view wherein a value is selected by the user and brand competitors are compared with respect to that value or (2) a brand value landscape view wherein a brand is selected by the user and brand values are compared as to that brand value; one or more servers on a computer network, the one or more servers configured to store tabular data including (1) a plurality of assigned user IDs for a plurality of users, (2) user demographics data including, age, gender and location for the plurality of users, (3) user data relating to one or more brands and (4) social media data relating to the one or more brands, the one or more servers programmed to: retrieve the assigned user IDs and the one or more brands and generate a database of tabular data including data within a plurality of rows of the assigned user IDs and the one or more brands; merge the user data relating to one or more brands and demographic data into the database; aggregate the social media data relating to the one or more brands by location and assigned user ID and merge the social media data into the database; determine expected purchase propensity score for every user of the plurality of users and brand in the second database by training a machine learning algorithm using a framework of (1) actual purchase data and (2) the user demographic data, brand data and the social media data relating to the brands to create a model for calculating a prediction value of likelihood of a user to purchase a brand; and calculate (1) a prediction value of likelihood of each user to purchase each brand based on the created model and (2) a residual value representing the accuracy of the calculated prediction value and merge prediction value and residual value in database.

### BRIEF DESCRIPTION OF DRAWINGS

FIG. 1 depicts a block diagram of an example environment in which the value return index system operates.

FIG. 2 depicts a block diagram of an example system shown in FIG. 1.

FIG. 3 depicts a block diagram of the architecture of an example server of the system shown in FIG. 1.

FIG. 4 depicts a flow diagram of the value return index system of a client shown in FIG. 1.

FIG. 5 depicts a block diagram illustrating flow of certain process steps of the flow diagram in FIG. 4.

FIG. 6 depicts a block diagram illustrating flow of certain process steps of the flow diagram in FIG. 4.

FIG. 7 a block diagram illustrating flow of certain process step of the flow diagram in FIG. 4.

FIG. 8 a block diagram illustrating flow of certain process step of the flow diagram in FIG. 4.

FIG. 9 depicts a block diagram flow of a client device using system 102 to group the data in the primary database and display a brand landscape view or a value landscape view of data using value consideration data.

FIG. 10 depicts example tabular data in a database with user IDs along with brands.

FIG. 11 depicts the example tabular in FIG. 10 illustrating added user data including certain brand values and purchase brand data.

FIG. 12 depicts the example tabular data in FIG. 11 including social media activity (by count and sentiment).

FIG. 13 depicts the example tabular data in FIG. 12 including predicted purchase data values.

FIG. 14 depicts the tabular data of FIG. 13 including residual value data.

FIG. 15 depicts example tabular data in a database including brand, brand value, average predicted purchase, average adjusted residual values and value consideration values.

FIG. 16 depicts a user interface including a dashboard along with an example chart illustrating a brand landscape view.

FIG. 17 depicts another example user interface including a dashboard along with an example chart illustrating brand value landscape view.

FIG. 18 depicts an example user interface including a dashboard along with a table with value awareness for every brand and every brand value.

### DETAILED DESCRIPTION OF THE INVENTION

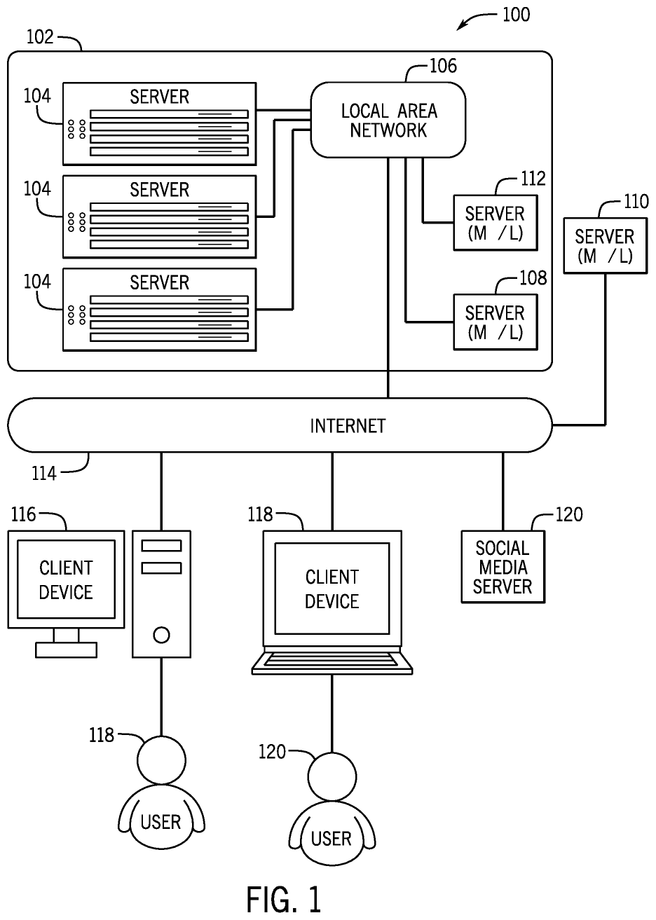

FIG. 1 depicts a block diagram of an example environment 100 in which value return index (VRI) system 102 operates. In brief, VRI system 100 is a tool that accurately quantifies the financial impact of the top of the marketing funnel as discussed in more detail below.

System 102 incorporates several servers 104 that are internally connected via a local area network 106 (LAN) as known to those skilled in the art. Servers 104 may be connected directly or through one or more networking devices such as routers. Servers 104 may utilize a variety of networking protocols (e.g., Ethernet) and logic networking protocols (e.g., Internet Protocol (IP), Transmission Control Protocol (TCP), and/or a User Datagram Protocol (UDP). Local area network 106 may be (1) a wired network including coaxial cable, TI, T2, T3, or T4 type lines, Integrated Services Digital Networks (ISDNs), Digital Subscriber Lines (DSLs), wireless links including satellite links, or other communication links or channels as may be known to those skilled in the art or a wireless network employing a WIFI or other wireless protocols as known to those skilled in the art. Local area network 106 may be structured according to one or more network architectures such as server/client, peer-to peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the system 102.

System 102 further includes servers 108, 112 and server 110 with machine learning (M/L) platforms/algorithms that are connected to LAN 106 and Internet 114, respectively. Servers 104 may access data from machine learning servers 108,112 via LAN 106 and access data from machine learning server 110 via Internet 110. Three servers are shown but any number of servers may be employed as known to those skilled in the art.

In this environment 100, LAN 106 is connected to client devices 116,118 via Internet 114 that allows servers 104 to exchange data with client devices 116,118 such as laptops, personal computers, mobile devices as well as other third party system servers such as machine learning server 110 and social media server 120. Two client devices are shown but any number of client devices may be employed as known to those skilled in the art.

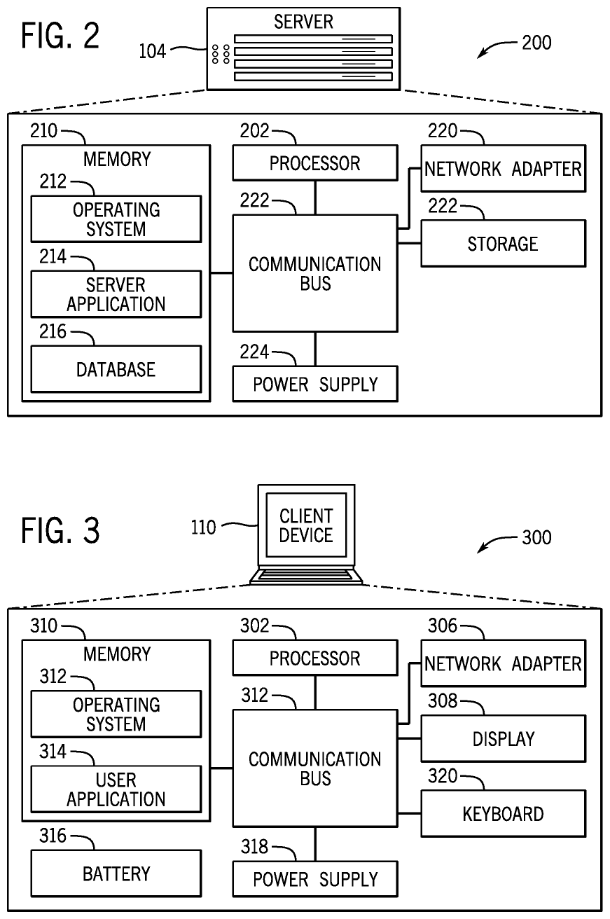

FIG. 2 depicts a block diagram of the architecture of an example server of the system 102 shown in FIG. 1. Server 104 may comprise one or more processors 202 that process instructions. The one or more processors 202 may include multiple cores, coprocessors or an integrated graphical processing unit (GPU) and/or one or more layers of local cache memory. Servers 104 each may comprise memory 210 configured to store various applications including an operating system 212, server applications 214, such as a hypertext transport protocol (HTTP) server, a file transfer protocol (FTP) server, or a simple mail transport protocol (SMTP) server; and/or various forms of data, such as a database 216 or a file system.

Servers 104 may comprise a variety of peripheral components, such as a wired and/or wireless network adapter 218 connectible to a local area network and/or wide area network; one or more storage components 220, such as a hard disk drive, a solid-state storage device (SSD), a flash memory device, and/or a magnetic and/or optical disk reader.

Servers 104 may each comprise one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. Other components that may optionally be included with server 104 (though not shown) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

Servers 104 may each comprise a dedicated and/or shared power supply 218 that supplies and/or regulates power for many other components.

FIG. 3 depicts a block diagram of the architecture of an example client device of the system shown in FIG. 1. Client device 118,120 may each comprise one or more processors 310 that process instructions. The one or more processors 310 may optionally include multiple cores; one or more coprocessors, such as a mathematics coprocessor or an integrated graphical processing unit (GPU); and/or one or more layers of local cache memory. Client device 118,120 may comprise memory 310 storing various forms of applications, such as an operating system 312; one or more user applications 314, such as document applications, media applications, file and/or data access applications, communication applications such as web browsers and/or email clients, utilities, and/or games; and/or drivers for various peripherals.

Client devices 118,120 may each also comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 320, a mouse, a microphone, a camera, and/or a touch sensitive component of the display 308. Other components that may optionally be included with the client device 118,120 (though not shown) include one or more storage components, such as a hard disk drive, a solid-state storage device (SSD).

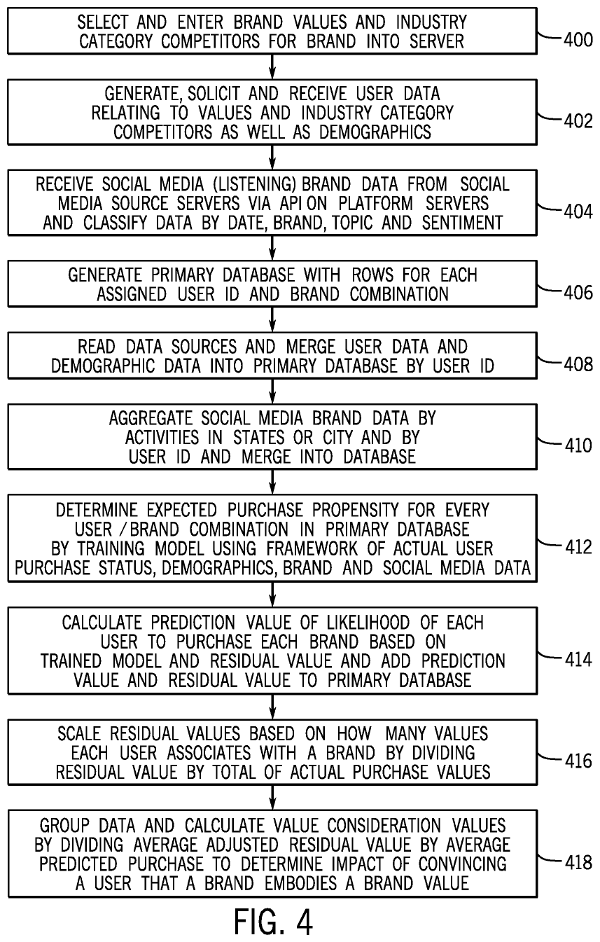

FIG. 4 depicts a flow diagram (flowchart) of the process steps for determining a value return index (VRI) performed by VRI system 102 disclosed herein. As described above, VRI system 100 is a tool that accurately quantifies the financial impact of the upper part of the purchasing funnel by generating scores across several categories (e.g., environmentalism, affordability, customer service, patriotism, equality and diversity). VRI helps a brand understand what elements of the brand are driving revenue, losing revenue and how the brand compares to its competitors. For example, a brand might learn that their efforts towards equality are driving significant revenue to the business and therefore, the brand needs to continue and increase strategies toward equality. The VRI system is critical for driving the strategy of a brand, brand spending, targeting the type of consumers, and the messaging of the brand in advertisements.

To this end, the process begins with step 400 wherein brand values are selected and entered into servers 104 along with brand industry competitors. Each brand will define its core company values as part of its advertising strategy and campaigns. Examples of such values may include environmentalism, affordability, customer service, patriotism, equality, sustainability, innovation, security, health, quality, and diversity. Other values may be used. For example, Costco may believe diversity and equality in hiring is paramount to its marketing strategy and future marketing campaigns. These values can also be referred to as attributes, differentiators or characteristics of a brand. As part of this step, brands will also identify its company competitors. For example, if the brand is in the fast-food industry, the brand might look at McDonald's, Taco Bell, Burger King, and Wendy's as competitors.

Given the values and competitors, the process execution proceeds to step 402 wherein user (consumer) data (many users) is solicited and received relating to the brand values and brand competitors as well as demographic data of those users. This data may be solicited via electronic surveys, emails, portal access or other means known to those skilled in the art. The user data will help understand user perception of the brand. For example, data may include answers to a question such as “Which of the following stores do you think treats their employees well?” A) Walmart, B) Target, C) Costco, D) Aldi, E) Kroger, F) None of the above. Any number of questions may be used that have a material effect on an outcome. The nature of the questions or solicitation may involve numeral ratings, binary choices (yes/no). These are examples. The user data may also include (1) meta data such as time of obtained data, browser used, length of time to enter the data and (2) geolocation data of user providing the data to verify or support the accuracy of the purchases of the users. The user data may also include credit card data (to verify purchases).

Execution proceeds to step 404 wherein raw social media (listening) data is received from social media servers relating to the brand data via an API on platform servers 104. The data is broken down by date, brand topic and sentiment. For example, a row of data may indicate that on Jan. 20, 2021, a tweet about McDonalds mentioned the quality of the food and positive sentiment. User data and brand data may come from any number of sources known to those skilled in the art. That is, multiple sources of stream data may be incorporated to ultimately determine a value return index as described in more detail below.

Execution proceeds to step 406 wherein a primary database of tabular data is generated wherein rows for assigned user ID data and brand data are entered in the tabular data fields of the primary database. FIG. 10 depicts an example database of tabular data with user IDs along with brands. Every user is assigned an identification (ID) by system 102 for user anonymity. In FIG. 10, brands such as Walmart, Aldi and Costco are identified.

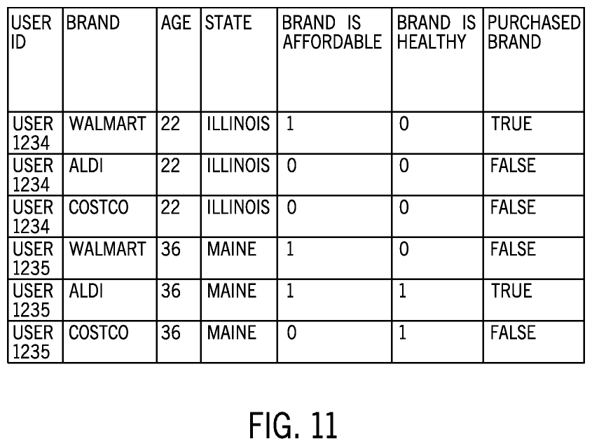

Execution of the process proceeds to step 408 wherein data sources such as user data (above) and demographic data are read and merged into the primary database as shown in FIG. 11. User age, location and numeral assignments associated with brand values are included. In FIG. 11, the user's demographic data including age, state and entered data associated with affordability and health are shown. Actual purchase data is also included. In this example, brand values are assigned binary values (“1” or “0”) that are associated with affordability and health. For example, User 1234 has rated Walmart as affordable (1) but not healthy (0). User 1234 is identified as a purchaser of Walmart (TRUE).

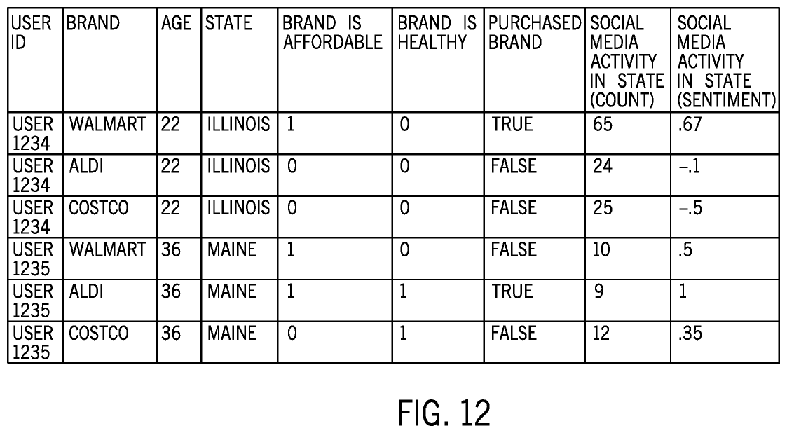

Execution proceeds to step 410 wherein social media brand activity is aggregated/calculated by location and merged as tabular data entries into the primary database. FIG. 12 depicts the tabular data with social media activity is generated. Social media brand activity is divided or scored by user volume and sentiment. User volume is tallied and scaled (or normalized) for values between 1-100 preferably. If for example, 1000 individual data count (e.g., tweets, reddit comments, and Facebook mentions) exists and 750 data count relating to a brand, then 750 is divided by 1000 and then multiplied by 100 for scaling purposes. The result is 75. In the database table shown in FIG. 12, 65 is the scaled or normalized value of social media posts of individuals that mention or relate to Walmart (the particular brand). Sentiment is calculated by word scoring in a positive or negative way and total number of scores (social media posts). In this example, social media posts are as assigned +1 or −1 based on positive or negative sentiment associated with the brand. For example, if there are 3 tweets relating to Aldi, 2 of which are positive and 1 negative, then the calculation appears as follows: (1+1+−1)/3=0.33. This value is another record in the tabular data shown in FIG. 12. In the example shown, social media activity is associated with (in) Illinois and Maine. However, any location may be defined such as by city or country.

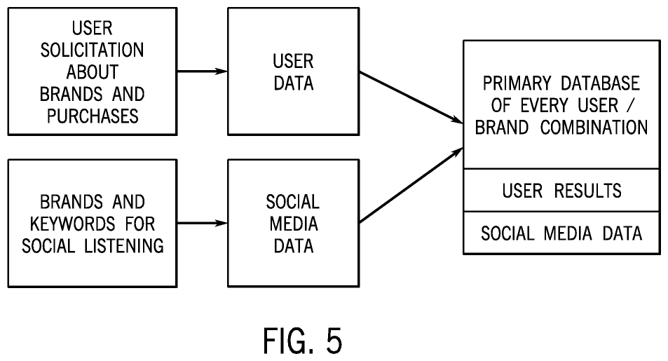

FIG. 5 depicts a block diagram flow illustrating a summary of the process steps 400-410. As shown, primary database is generated of tabular data with user data based on user solicitation about brands and purchases and social media data based on brand scoring described above.

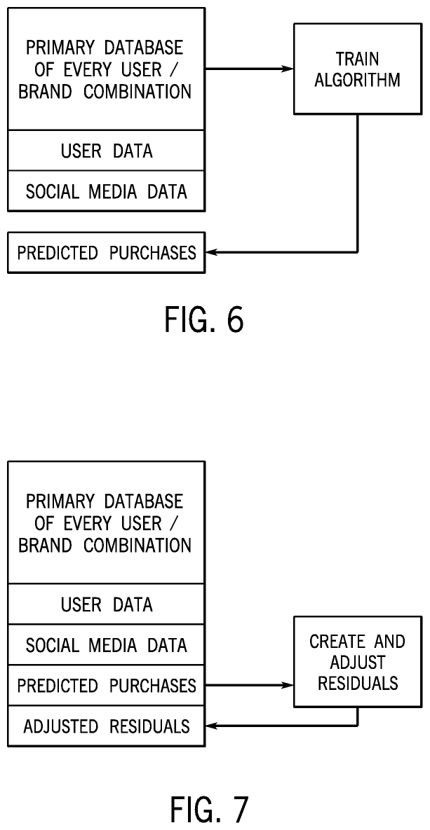

Execution proceeds to step 412 wherein VRI system 102 determines an expected purchase propensity (prediction data value below) for every user and brand combination in the primary database by training a model using a framework of actual user purchase status, demographics and social media data. Such purchase propensity data values are obtained using one or more machine learning algorithms (M/L) on servers 108,110,112 as the training model. In this example, an ensemble machine learning algorithm as known to those skilled in the art maybe used for training the model. The machine learning model uses n-fold cross validation system to minimize out of sample root mean squared error as known to those skilled in the art. (However, other machine learning models may be used to achieve desired results as known to those skilled in the art.) The model is defined using a framework as follows: Y=purchase or not and Xₛ=[demographic variables], [brand], [social media data]. It is important to note that the user data concerning brand values are not included in Xₛ variables. That is, the training model uses all data that exists about the users such as age, gender, education, location/geographic, except the user data relating to brand values. (Other Xₛ variables unrelated to the brand may be used such as vehicle market if the brand category is automobile industry.) In this way, the model may better predict if a user will purchase a brand or not. Machine learning algorithms may be locally used or third party algorithms such as open source model framework called H20.ai may be used. FIG. 6 depicts a block diagram of summary step 412. In this respect, the algorithm is trained with the (limited) user data and social media data in the primary database and an expected purchase propensity (prediction value described below) is now set to be determined based on this model.

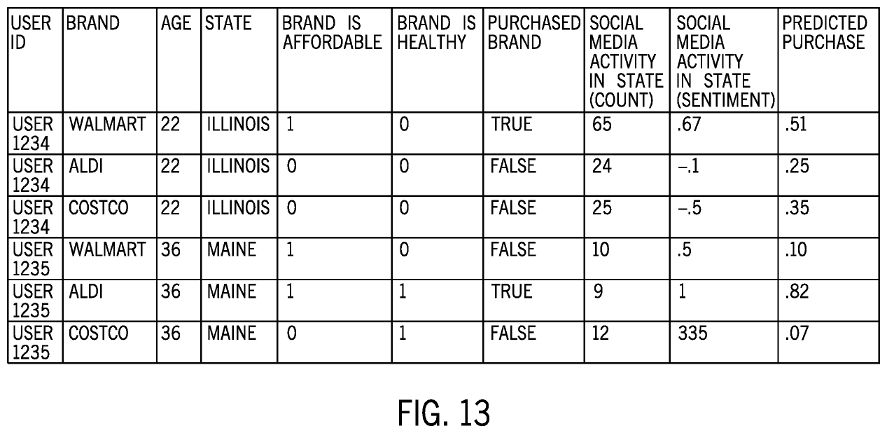

Execution proceeds to process step 414 wherein a prediction value is calculated of likelihood of each user to purchase each brand based on the trained model along with a residual value. That is, with the trained algorithm model, a prediction can be made of the likelihood of each user to buy each brand. FIG. 13 depicts the table shown in FIG. 12 but predicted purchase values entries are listed. For example, user 1234 will have a predicted purchase value of 0.51 for Walmart. So, there is a 51% chance that user 1234 will purchase from Walmart as a brand.

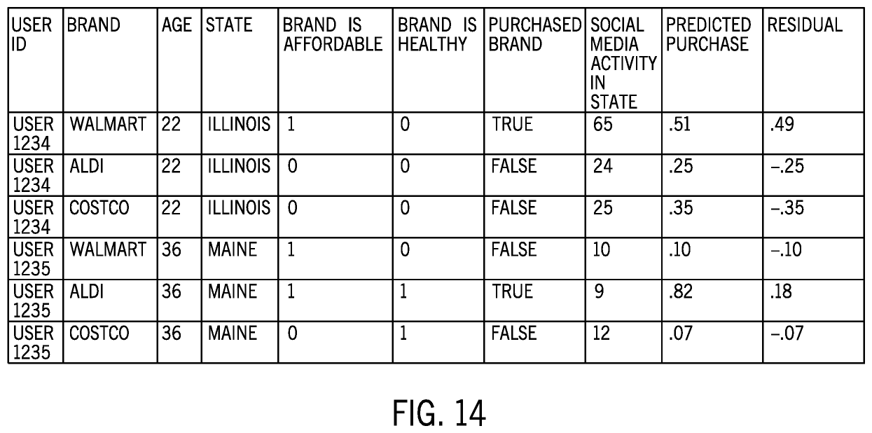

Now, each prediction value will have a residual value representative of the accuracy of the prediction. That is, the residual value represents how much the algorithm calculation was incorrect. Or stated in another way, the residual represents how much a purchase cannot be explained by demographics, social media and any other Xₛ variables included in the model. For example, if the predicted purchase is 0.80 and the user did purchase from Walmart, then the residual value will be 1−0.80=0.20. If the user did not purchase, then the residual value would be negative: 0−0.80=−0.80. In this example, a binary choice (1 or 0) is selected for purchase or not purchased values but it is possible to change that to reflect number of dollars spent which may be preferable for some other categories as known to those skilled in the art. FIG. 14 depicts the tabular data including the residual values.

Execution proceeds to step 416 wherein the residual values are scaled based on number of values each user associates with a brand. As stated above, the residual represents how much a purchase cannot be explained by demographics, social media and any other Xₛ variables included. The residual values are thus adjusted, i.e., scaled, by how many values the user (consumers) associates with that brand. This is accomplished by dividing residual value by total of the actual purchase values as follows: Adjusted Residual=residual/(sum of yes values). For example, if a user's residual for Walmart is 0.35 and the user selected “yes” for five brand values for Walmart, the then the adjusted residual is 0.35/5=0.07. This calculation is performed as most users (consumers) associate more than one value with each brand. So, scaling the residual calculated value enhances the accuracy of the impact each brand value has on sales. FIG. 7 depicts a block diagram of summary steps 414 and 416. Adjusted (scaled) residuals are the outcome.

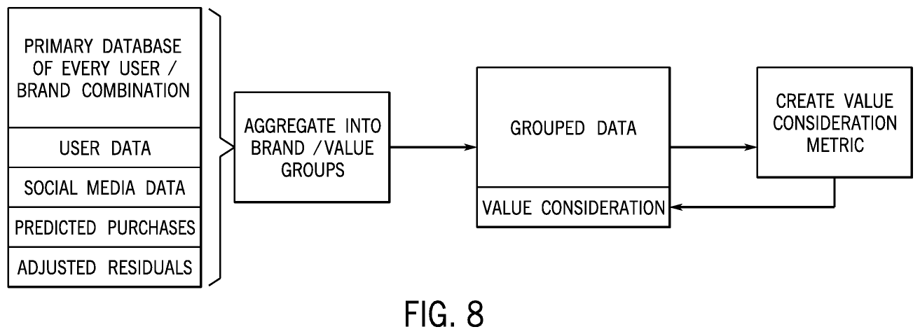

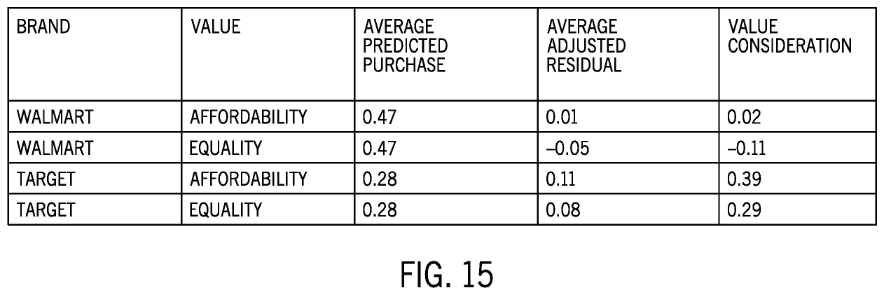

Execution proceeds (and ends) at step 418 wherein the data is grouped in various configurations and value consideration, i.e., value return index is calculated. The calculation is accomplished by dividing the average adjusted residual by the average predicted purchase: Value Consideration=average (adjusted residual)/average (predicted purchase). If the value consideration is above zero, then more users are buying from that brand than can be explained using demographics, social media or brand awareness. This ultimately means that a person associating that value with that particular brand has a positive effect on purchases. FIG. 8 is a block diagram flow of step 418 wherein the user data, social media data, predicted purchases and adjusted residuals are aggregated into brand value groups as desired. With the grouped data, a value consideration metric is created. FIG. 15 depicts the tabular data including value consideration data values or scores.

With the value consideration data value or score, a brand will understand the impact of convincing a user (consumer) that the brand embodies that value. For example, in the table shown in FIG. 25, Target's value consideration for the value of affordability is 0.39. That means that if Target convinces a user (consumer) that Target is affordable, then that person's purchase propensity increases by 39% on average. Thus, the value consideration value is unique and useful in that it can easily convert to dollars by multiplying by the average annual user (customer) value. In the example of Target, if Target's average annual customer value is $1500, convincing a consumer of the brand's value of affordability is worth: 0.11×$1500=$165. This financial metric is a major value and key benefit of this system.

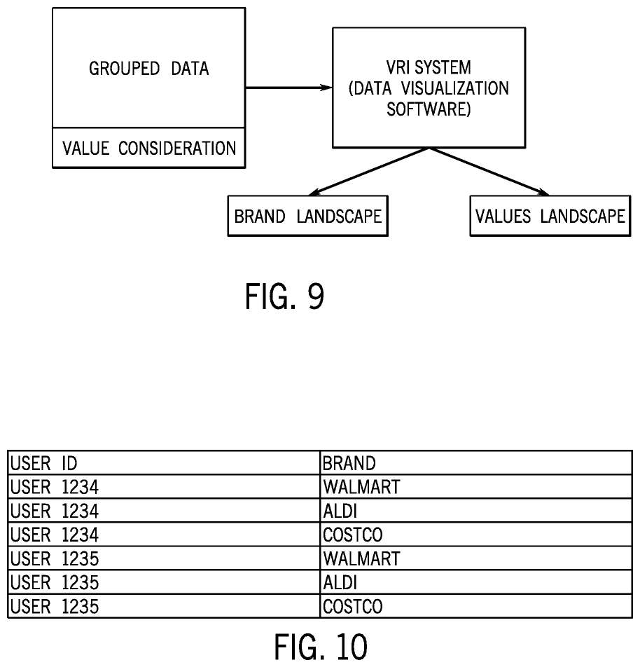

Data analysis is important, but displaying the data in useful ways is also important. VRI system 102 offers customizable interfaces for the data that enhances its usefulness and understanding of the delivered data to a brand. FIG. 9 depicts a block diagram flow of a client device using system 102 to group the data in the primary database and display a brand landscape view of data or a value landscape view of data using value consideration data. This is described in more detail below.

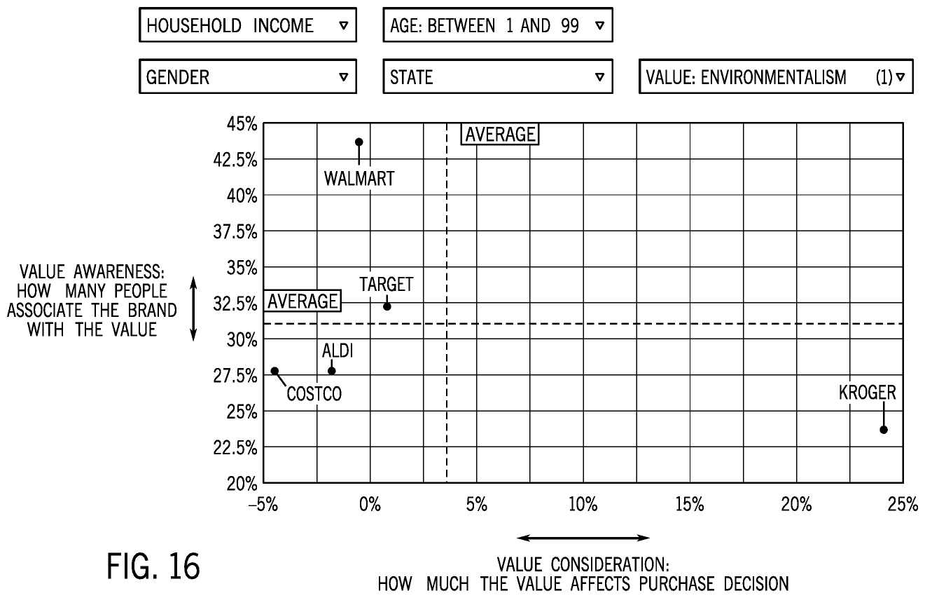

FIG. 16 depicts a user interface including a dashboard along with an example chart illustrating a brand landscape. In this interface, a user of the dashboard selects a brand value to view how the different brands compare on two dimensions: value awareness and value consideration. Value awareness is the percent of users (consumers) that identified (yes) that the brand is associated with that value. In this example, Walmart's value awareness for environmentalism is 44%, but with a slightly below zero value consideration. This landscape view or interface may be sliced by income, age, gender and location. However, other slicing designations may be added.

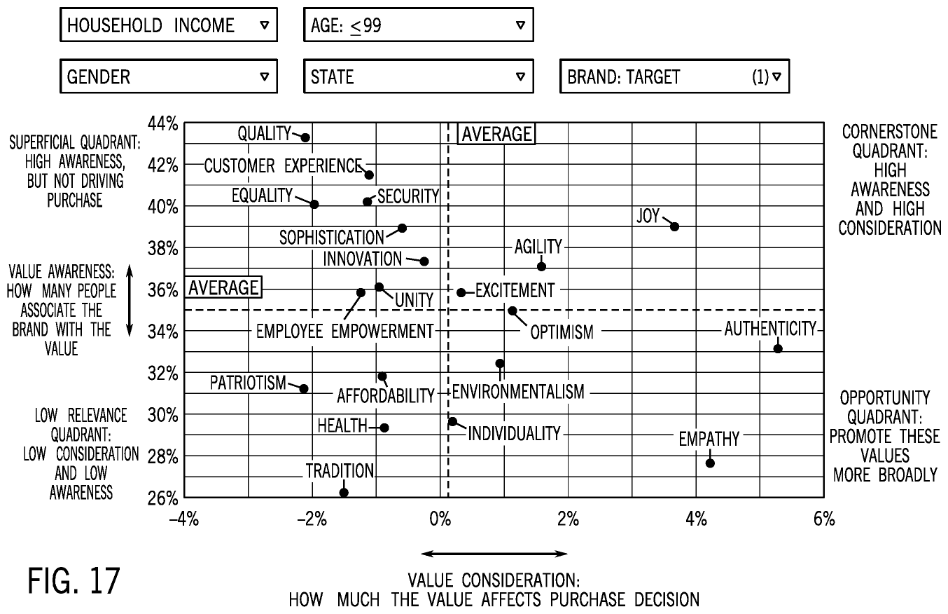

FIG. 17 depicts another example user interface including a dashboard along with an example chart illustrating value landscape. In this interface or view, the user of the dashboard selects one brand, and then compares the value awareness and value consideration for different values rather than different brands. In the example interface, the value of Joy is Target's best value classification, with high value awareness and high value consideration. The values of empathy and authenticity represent the brand's best opportunities for promotion, as they are driving high purchase propensity, but have plenty of headroom to promote with users (consumers).

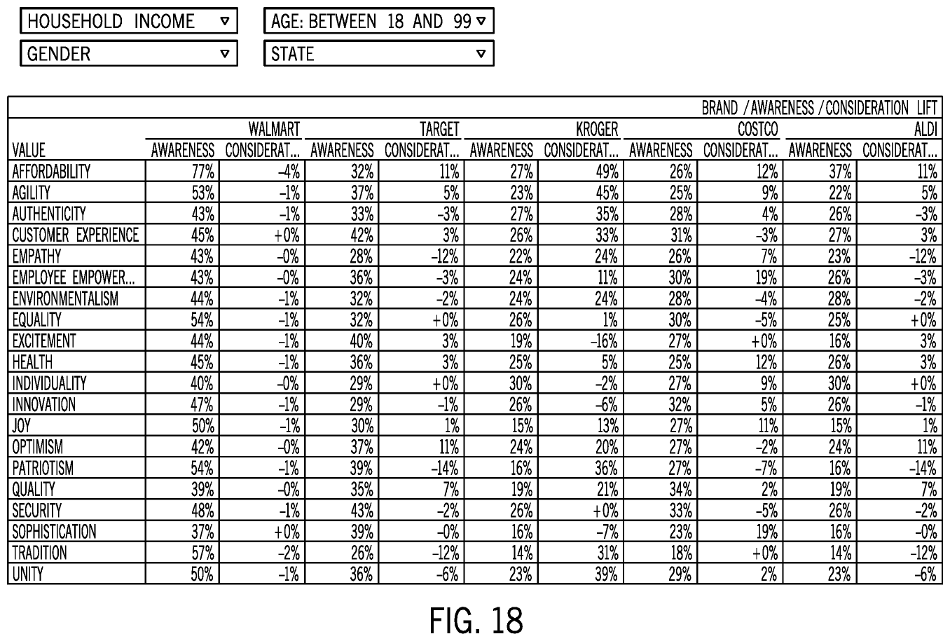

FIG. 18 depicts an example user interface with a dashboard along with a table with value awareness for every brand and every value that can be seen together all at once.

In summary, VRI system 102 is configured to measure revenue implications of a brand's awareness.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A value return index system comprising:
(a) a first database for storing tabular data including (1) a plurality of assigned user IDs for a plurality of users, (2) corresponding user demographics data including, age, gender and location for the plurality of users, (3) corresponding user data relating to one or more brands and (4) social media data relating to the one or more brands and (b) one or more servers communicating with the database and programmed to:
retrieve the assigned user IDs and the one or more brands from the first database and generate a second database of tabular data including data within a plurality of rows of the assigned user IDs and the one or more brands;
merge the user data relating to one or more brands and demographic data into the second database;
aggregate the social media data relating to the one or more brands by location and assigned user ID and merge the social media data into the second database;
determine expected purchase propensity score for every user of the plurality of users and brand in the second database by training a machine learning algorithm using a framework of (1) actual purchase data and (2) the user demographic data, brand data and the social media data relating to the brands to create a model for calculating a prediction value of likelihood of a user to purchase a brand; and
calculate prediction value of likelihood of each user to purchase each brand based on the created model and a residual value representing the accuracy of the calculated prediction value and merge prediction value and residual value in database.

2. The value return index system of claim 1 wherein the one or more servers are further programmed to scale the residual values based on number of brand values each user associates with a brand.

3. The value return index system of claim 2 wherein scaling residual values includes dividing the residual value by total number of actual purchase values

4. The value return index system of claim 3 wherein the one or more servers are further programmed to group data in the database relating to a brand value and calculate a value consideration values by dividing average adjusted residual by average predicted purchase to determine impact of that a brand that embodies that value.

5. A value return index method comprising:
receiving over a computer network, at one or more servers, tabular data including (1) a plurality of assigned user IDs for a plurality of users, (2) corresponding user demographics data including, age, gender and location for the plurality of users, (3) corresponding user data relating to one or more brands and (4) social media data relating to the one or more brands;
retrieving, by the one or more servers, the assigned user IDs and the one or more brands and generate a database of tabular data including data within a plurality of rows of the assigned user IDs and the one or more brands;
merging, by the one or more servers, the user data relating to one or more brands and demographic data into the database;
aggregating, by the one or more servers, the social media data relating to the one or more brands by location and assigned user ID and merge the social media data into the database;
determining, by the one or more servers, an expected purchase propensity score for every user of the plurality of users and brand in the database by training a machine learning algorithm using a framework of (1) actual purchase data and (2) the user demographic data, brand data and the social media data relating to the brands to create a model for calculating a prediction value of likelihood of a user to purchase a brand; and
calculating, by the one or more servers, a prediction value of likelihood of each user to purchase each brand based on the created model and a residual value representing the accuracy of the calculated prediction value and merge prediction value and residual value in database.

6. The value return index method of claim 5 further comprising scaling the residual values based on number of brand values each user associates with a brand.

7. The value return index method of claim 6 wherein the scaling residual values includes dividing the residual value by total number of actual purchase values

8. The value return index method of claim 7 further comprising grouping data in the database relating to a brand value and calculate a value consideration values by dividing average adjusted residual by average predicted purchase to determine impact of that a brand that embodies that value.

9. A value return index system comprising:
a user interface via a user client device on a user on a computer network, the user interface including one or more fields to receive user data selections to display (1) a brand landscape view wherein a value is selected by the user and brand competitors are compared with respect to that value or (2) a brand value landscape view wherein a brand is selected by the user and brand values are compared as to that brand value;
one or more servers on a computer network, the one or more servers configured to store tabular data including (1) a plurality of assigned user IDs for a plurality of users, (2) user demographics data including, age, gender and location for the plurality of users, (3) user data relating to one or more brands and (4) social media data relating to the one or more brands, the one or more servers programmed to:
retrieve the assigned user IDs and the one or more brands and generate a database of tabular data including data within a plurality of rows of the assigned user IDs and the one or more brands;
merge the user data relating to one or more brands and demographic data into the database;
aggregate the social media data relating to the one or more brands by location and assigned user ID and merge the social media data into the database;
determine expected purchase propensity score for every user of the plurality of users and brand in the database by training a machine learning algorithm using a framework of (1) actual purchase data and (2) the user demographic data, brand data and the social media data relating to the brands to create a model for calculating a prediction value of likelihood of a user to purchase a brand; and
calculate (1) a prediction value of likelihood of each user to purchase each brand based on the created model and (2) a residual value representing the accuracy of the calculated prediction value and merge prediction value and residual value in database.

10. The value return index system of claim 9 wherein the one or more servers are further programmed to scale the residual values based on number of brand values each user associates with a brand.

11. The value return index system of claim 10 wherein scaling residual values includes dividing the residual value by total number of actual purchase values.

12. The value return index system of claim 11 wherein the one or more servers are further programmed to group data in the database relating to a brand value and calculate a value consideration value by dividing average adjusted residual by average predicted purchase to determine impact of that a brand that embodies that brand value.

13. The value return index system of claim 12 wherein the one or more servers are further programmed to receive a selection request for displaying a brand value landscape view wherein brand competitors are compared as to brand value awareness and the calculated value considerations.

14. The value return index system of claim 13 wherein the one or more servers are further programmed to receive a selection request for displaying a brand landscape view wherein a brand is selected by the user and brand values are compared with respect to value awareness and calculated value considerations.

15. The value return index system of claim 13 wherein the one or more servers are further programmed to display the brand landscape view over the computer network wherein the brand values are compared with respect to calculated value considerations.

16. The value return index system of claim 14 wherein the one or more servers are further programmed to display the brand value landscape view wherein the brand competitors of that brand are compared as to that brand value and calculated value considerations.
